(19) United States
(12) Patent Application Publication
(10) Pub. No.: US 2014/0152898 A1
(43) Pub. Date: Jun. 5, 2014

(54) SYSTEM AND METHOD CAPABLE OF CHANGING TV PROGRAMS

(71) Applicants: YUN ZHAO, Shenzhen (CN); CHIH-SAN CHIANG, New Taipei (TW); HUA-DONG CHENG, Shenzhen (CN); CHUN-HUI LIN, Shenzhen (CN)

(72) Inventors: YUN ZHAO, Shenzhen (CN); CHIH-SAN CHIANG, New Taipei (TW); HUA-DONG CHENG, Shenzhen (CN); CHUN-HUI LIN, Shenzhen (CN)

(21) Appl. No.: 13/727,528

(22) Filed: Dec. 26, 2012

(30) Foreign Application Priority Data
Dec. 4, 2012 (CN) 201210510472.2

(51) Int. Cl. H04N 5/50

(52) U.S. Cl. CPC H04N 5/50
USPC 348/731

(57) ABSTRACT

A system capable of changing TV programs includes a TV set and a remote control apparatus. The remote control apparatus includes a first user information obtaining unit mounted outside of the remote control apparatus. The TV set includes a database, a user information processing unit, and a control unit. The database pre-stores a first table recording relationships between a plurality of user information and a plurality of preferable TV programs corresponding to each of the plurality of user information. The control unit determines the preferable TV programs of the determined user information according to the first table stored in the database, and controls the display unit to display the determined preferable TV programs. A related method is also disclosed.

### BACKGROUND

1. Technical Field

The present disclosure relates to a technology of telecontrolling, and particularly to a system and method capable of changing TV programs.

2. Description of the Related Art

Users commonly use remote control apparatus to choose and change television (TV) programs. However, the user must either operate a plurality of buttons mounted on the remote control apparatus to select a desired TV program, or must operate a button corresponding to channel number of the desired TV channel. Furthermore, the remote control apparatus cannot accurately change the TV programs according to each particular user.

Therefore, there is room for improvement within the art.

### BRIEF DESCRIPTION OF THE DRAWINGS

The components in the drawings are not necessarily drawn to scale, the emphasis instead being placed upon clearly illustrating the principles of the disclosures. Moreover, in the drawings, like reference numerals designate corresponding parts throughout the several views.

FIG. 1 is a block diagram of a system capable of changing TV programs in accordance with a first exemplary embodiment.

FIG. 2 is a block diagram of a system capable of changing TV programs in accordance with a second exemplary embodiment.

FIG. 3 is a flowchart of a method capable of changing TV programs in accordance with an exemplary embodiment.

### DETAILED DESCRIPTION

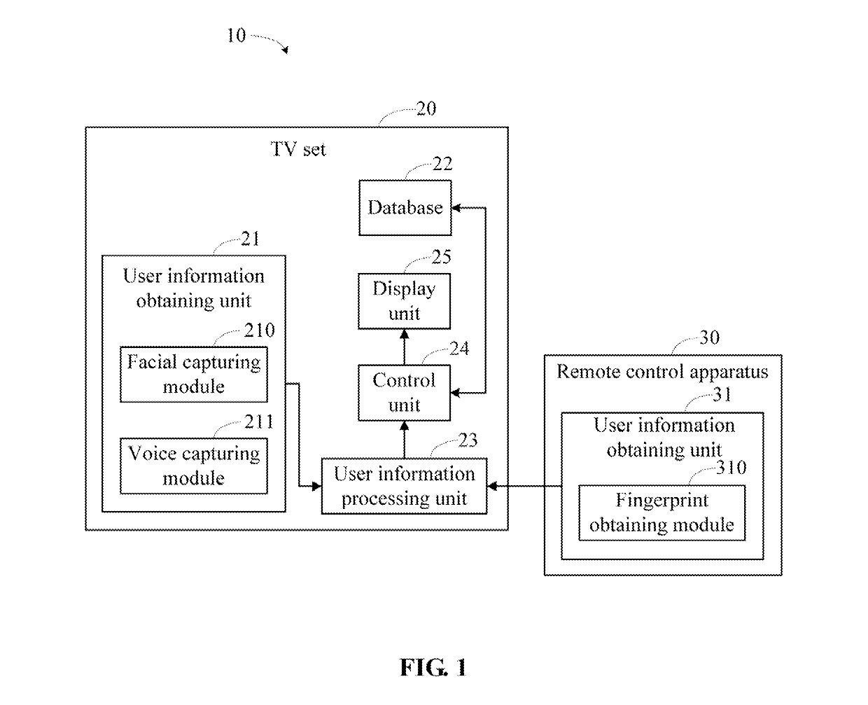

Referring to FIG. 1, a system capable of changing TV programs is employed in accordance with a first exemplary embodiment. The system 10 includes a TV set 20 and a remote control apparatus 30. The remote control apparatus 30 is configured for transmitting a remote control signal to the TV set 20, such as an infrared remote control signal, to control the TV set 20 to be turned on or off, or change TV programs in response to the remote control signal.

The TV set 20 includes a user information obtaining unit 21, a database 22, a user information processing unit 23, a control unit 24, and a display unit 25. The database 22 is configured for storing a first table recording relationships between user information of a plurality of users and a plurality of preferred TV programs corresponding to each user. The user information of each user includes a fingerprint, a facial image, or a voice segment. In the embodiment, the remote control apparatus 30 also includes a user information obtaining unit 31 mounted toward outside thereof. The user information obtaining unit 31 includes a fingerprint obtaining module 310 mounted toward outside of the remote control apparatus 30. The fingerprint obtaining module 310 is configured for obtaining a fingerprint of a user after being activated and touched by a finger of the user. The remote control apparatus 30 transmits a wireless signal carrying the fingerprint to the TV set 20. The user information obtaining unit 21 includes facial image capturing module 210 and a voice capturing module 211 both mounted toward outside of the TV set 20. In the embodiment, the facial image capturing module 210 is a camera, and the voice capturing module 211 is a microphone.

The user information processing unit 23 is configured for processing and analyzing the user information obtained by the user information obtained unit 21 and 31. The control unit 24 is configured for determining preferred TV programs of a user corresponding to the user information provided by the user information processing unit 23 according to the first table stored in the database 22, and controls the display unit 25 to display a list of the preferred TV programs for the user to select. The remote control apparatus 30 is operated by user to transmit a remote control signal to the TV set 20 to select a preferred TV program from the list displayed on the display unit 25.

In the embodiment, if the user information processing unit 23 receives the user information obtained by the user information obtaining unit 21 and the user information carried by the remote control signal from the remote control apparatus 30 within a predetermined time interval, such as 5 seconds, the user information processing unit 23 processes the user information whichever is received first and ignore the latter.

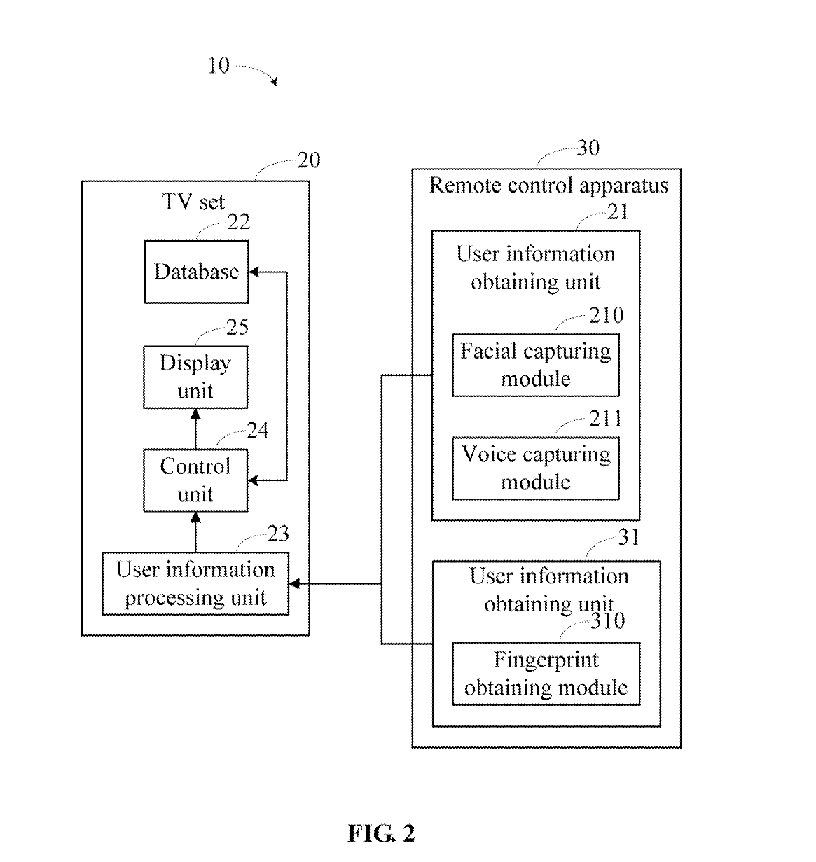

Referring to FIG. 2, in the second embodiment, the user information obtaining unit 21 is not installed on the TV set 20 but on the remote control apparatus 30. The remote control apparatus 30 includes a plurality of mechanical buttons (not shown) mounted toward outside thereof for user to operate the facial image capturing module 210, the voice capturing module 211, and the fingerprint obtaining module 310 to obtain the user information. The remote control apparatus 30 transmits the user information obtained by the user information obtaining unit 21 and/or 31 to the TV set 20. The TV set 20 determines preferable TV programs corresponding to the user information transmitted by the remote control apparatus 30 and displays a list of the preferable TV programs.

When the list of the preferable TV programs is displayed on the TV set 20, the user can select one of the preferable TV programs on the list. If the user selects one, the TV set 20 changes to the channel of the selected preferable TV program. In the embodiment, the user can also select TV programs beyond (i.e., not recorded in) the list by operating the remote control apparatus 30 or buttons equipped on the TV set 20. For example, the user can firstly cancel the display of the list by operating a particular button and then change the TV set 20 to a desired channel. When a preferred TV program is displayed on the TV set 20, the control unit 24 can move the TV program out of the list of preferable TV programs by operating a particular button on the remote control apparatus 30. When a non-preferred TV program is displayed on the TV Set 20, the user can add the TV program to the list of preferred TV programs by operating a particular button on the remote control apparatus 30.

The database 22 is further configured for storing a second table recording relationships between the plurality of user information and a plurality of TV programs which are forbidden to be displayed corresponding to each of the plurality of user information. When the user having a user information selects a TV program via operating the remote control apparatus 30, the control unit 24 determines whether the TV programs are forbidden or not forbidden corresponding to the user information according to the second table, and the forbidden TV programs are not to be displayed to the user.

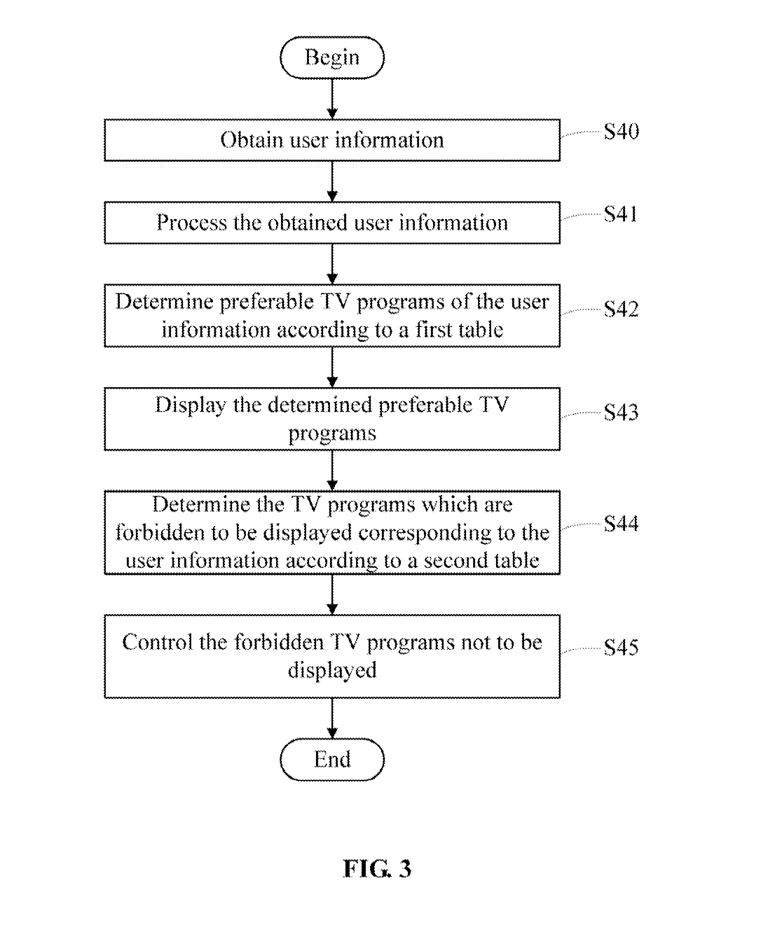

FIG. 3 is a flowchart of a method capable of change TV programs.

In step S40, the user information obtaining unit 21 and/or 31 obtains user information.

The user information of each user includes a fingerprint, a facial image, or a voice segment.

In the first embodiment, the user information obtaining unit 21 is mounted on the TV set 20, and includes the facial image capturing module 210 and the voice capturing module 211. The user information obtaining unit 31 is mounted on the remote control apparatus 30, and includes a fingerprint obtaining module 310 mounted outside of the remote control apparatus 30.

In the embodiment, the facial image capturing module 210 is a camera, and the voice capturing module 211 is a microphone.

In the second embodiment, the user information obtaining unit 21 and 31 are both mounted on the remote control apparatus 30. The remote control apparatus 30 includes a plurality of mechanical buttons (not shown) mounted outside thereof for user to operate the facial image capturing module 210, the voice capturing module 211, and the fingerprint obtaining module 310.

In step S41, the user information processing unit 23 processes and analyzing the user information obtained by the user information obtained unit 21 and/or 31.

In step S42, the control unit 24 determines preferred TV programs of a user corresponding to the user information provided by the user information processing unit 23 according to the first table stored in the database 22.

The first table is pre-stored in the database 22, recording relationships between user information of a plurality of users and a plurality of preferable TV programs corresponding to each user.

In step S43, the control unit 24 controls the display unit 25 to display the determined preferable TV programs.

The control unit 24 controls the display unit 25 to display a list of preferable TV programs for the user to select. The remote control apparatus 30 is operated by user to transmit a remote control signal to the TV set 20 to select a preferred TV program from the list displayed on the display unit 25.

In step S44, the control unit 24 determines the TV programs which are forbidden to be displayed corresponding to the user information according to the second table.

The second table is pre-stored in the database 22, recording relationships between the plurality of user information and a plurality of TV programs which are forbidden to be displayed corresponding to each of the plurality of user information.

In step S45, the control unit 24 controls the forbidden TV programs are not be displayed to the user. The user having the user information can select a TV program which is not recorded in the first table via operating the remote control apparatus 30. The TV set 20 displays the selected TV program in response to a remote control signal transmitted by the remote control apparatus 30.

When the list of the preferred TV programs is displayed on the TV set 20, the user can select one of the preferred TV programs on the list. If the user selects one, the TV set 20 changes to the channel of the selected preferred TV program. In the embodiment, the user can also select TV programs beyond (i.e., not recorded in) the list by operating the remote control apparatus 30 or buttons equipped on the TV set 20. For example, the user can firstly cancel the display of the list by operating a particular button and then change the TV set 20 to a desired channel. When a preferred TV program is displayed on the TV set 20, the control unit 24 can move the TV program out of the list of preferred TV programs by operating a particular button on the remote control apparatus 30. When a non-preferred TV program is displayed on the TV set 20, the user can add the TV program to the list of preferred TV programs by operating a particular button on the remote control apparatus 30.

It is understood that the present disclosure may be embodied in other forms without departing from the spirit thereof. Thus, the present examples and embodiments are to be considered in all respects as illustrative and not restrictive, and the disclosure is not to be limited to the details given herein.

1. A system capable of changing TV programs comprising a TV set and a remote control apparatus, the remote control apparatus configured for controlling the TV set remotely;
the remote control apparatus comprising:
a first user information obtaining unit mounted toward an outside of the remote control apparatus, and configured for obtaining user information and transmitting a wireless signal carrying the obtained user information to the TV set;
the TV set comprising:
a display unit;
a database configured for pre-storing a first table recording relationships between user information of a plurality of users and a plurality of preferable TV programs;
a user information processing unit configured for processing and analyzing the user information obtained by the first user information obtained unit to identify a user; and
a control unit configured for determining preferable TV programs of the determined user according to the first table stored in the database, and controlling the display unit to display the determined preferable TV programs.

2. The system capable of changing TV programs as recited in claim 1, wherein the first user information obtaining unit comprises a fingerprint obtaining module for obtaining fingerprint of users.

3. The system capable of changing TV Programs as recited in claim 2, wherein the first user information obtaining unit further comprises a facial image capturing module for obtaining images of users and a voice capturing module for capturing voices of users.

4. The system capable of changing TV programs as recited in claim 1, wherein the TV set further comprises:
a second user information obtaining unit mounted toward an outside of the TV set, and configured for obtaining user information;
the control unit further configured for determining preferable TV programs of a user corresponding to the user information obtained by the second user information obtaining unit according to the first table stored in the database, and controlling the display unit to display the determined preferable TV programs.

5. The system capable of changing TV programs as recited in claim 4, wherein the second user information obtaining unit comprises a facial capturing module for obtaining images of users and a voice capturing module for capturing voices of users.

6. The system capable of changing TV programs as recited in claim 1, wherein the control unit is further configured for associating TV programs selected by a user with the user and adding the associated TV programs to the first table by operating the remote control apparatus.

7. The system capable of changing TV programs as recited in claim 1, wherein the first table is pre-set by a user by operating the remote control apparatus.

8. The system capable of changing TV programs as recited in claim 1, wherein the database is further configured for storing a second table recording relationships between user information of a plurality of users and a plurality of TV programs which are forbidden to be displayed corresponding to each of the users;
the control unit further configured for determining the TV programs which are forbidden to be displayed corresponding to the user information according to the second table, and forbidding the display of the determined TV programs.

9. A method capable of changing TV programs comprising:
obtaining user information of a user;
processing the obtained user information to identify the user;
determining preferable TV programs of the user according to a first table stored in a TV set, wherein the first table records relationships between user information of a plurality of users and a plurality of preferable TV programs corresponding to each of the plurality of users; and
displaying the determined preferable TV programs on a display unit of the TV set.

10. The method as recited in claim 9, further comprising:
determining the TV programs which are forbidden to be displayed corresponding to the user information according to a second table, wherein the second table records relationships between user information of a plurality of users and a plurality of TV programs which are forbidden to be displayed corresponding to each of the plurality of users; and
forbidding the display of the determined TV programs.
